(19) United States
(12) Patent Application Publication
(10) Pub. No.: US 2016/0190968 A1
(43) Pub. Date: Jun. 30, 2016

(54) ELECTRIC MOTOR WITH REDUNDANT ELECTRIC CIRCUITS

(71) Applicant: SAGEM DEFENSE SECURITE, Boulogne Billancourt (FR)

(72) Inventors: Jerome PIATON, Boulogne Billancourt (FR); Philippe ELIE, Boulogne Billancourt (FR)

(21) Appl. No.: 14/785,239

(22) PCT Filed: Apr. 16, 2014
(86) PCT No.: PCT/EP2014/057836

§ 371 Date: Feb. 18, 2016

(30) Foreign Application Priority Data
Apr. 18, 2013 (FR) 1353538

(51) Int. Cl. H02P 25/22; H02K 1/14; H02K 3/28

(52) U.S. Cl. CPC H02P 25/22; H02K 3/28; H02K 1/14

(57) ABSTRACT

An electric motor having a stator defining a number N, at least equal to two, of pairs of poles and a rotor mounted to pivot in the stator. The motor has a number n of electric circuits each defining two windings mounted on poles of the stator, the windings of all the circuits being substantially identical to each other, the number n of electric circuits being greater than the number N of pairs of poles and at least first and second electric circuits being mounted on a first of the pairs of poles and a third of the electric circuits being mounted on a second of the pairs of poles.

### BACKGROUND OF THE INVENTION

1. Field of the Invention

The present invention relates to an electric motor, more particularly a single-phase motor.

2. Brief Discussion of the Related Art

Such single-phase motors are for example used for moving flying surfaces in an aircraft equipped with electric flight controls.

Such electric motor comprises a stator defining a number at least equal to two, of pairs of poles and a rotor mounted to pivot in the stator. The motor comprises an electric circuit defining identical windings mounted on the poles of the stator so as to form the motor phases. The motor may be so arranged as to require a limited motion space. The desired motion space for the motor determines the number of pairs of poles: if one pair of poles is enough for a 180° maximum motion space, two pairs of poles are required for a 90° maximum motion space and three pairs of poles are required for a 60° maximum motion space.

For safety reasons, and more particularly in aeronautic applications, linking two motors equipped with their own motion transmission means with the same flying surface, with both motors being so dimensioned as to be able to move the flying surface alone is known. In case of failure of one motor, the other motor can thus move the flying surface. Such solution is relatively heavy and cumbersome.

Using an actuator with two or even three motors sharing the same output shaft has also been considered. Three stators are then mounted along the shaft, each one being positioned opposite one segment of the shaft which is so arranged as to form a rotor. Such solution is less heavy and less cumbersome while meeting the same safety requirements as the previous solution.

### BRIEF SUMMARY OF THE INVENTION

The invention aims at providing a motor complying with the same safety requirements in case of failure, while being less heavy and less cumbersome.

For this purpose, the invention provides for an electric motor comprising a stator defining a number N, at least equal to two, of pairs of poles and a rotor mounted to pivot in the stator. The motor comprises a number n of electric circuits each defining two windings mounted on poles of the stator and the windings of all the circuits are substantially identical to each other. The number n of electric circuits is greater than the number N of pairs of poles. At least a first one and a second one of the electric circuits are mounted on a first one of the pairs of poles and a third one of the electric circuits is mounted on a second one of the pairs of poles.

The motor of the invention thus comprises several electric circuits enabling the control of the motor so that the failure of one of the circuits does not prevent the motor from operating. The motor arrangement thus enables a redundancy of the electric circuits even for motors including a relatively low number of poles. This is particularly interesting for motors having a limited motion space.

According to a first embodiment of the invention, the windings of each one of the first and second electric circuits are mounted on different poles of the first pair of poles.

If the first or the second electric circuit fails, the motor can thus still be provided with the same torque, provided the feed current of the remaining electric circuit is increased.

According to one second embodiment of the invention, the windings of each one of the first and second electric circuits are mounted on the same pole of the first pair of poles.

Such embodiment is simpler than the first one. On the contrary, if the first or the second electric circuit fails, the motor can be provided with only half the maximum torque that could be supplied by the motor when both electric circuits are operational.

According to an advantageous embodiment of the stator:
each pole is formed with a tooth having an enlarged free end.
the stator is formed of angular sectors which each include one of the poles and which are assembled together.

The winding can thus be provided on each sector prior to the assembling together of the sectors, which makes the production of the stator simpler.

The number N of pairs of poles is then preferably equal to two and the stator has a cross-section with a square-shaped outer profile.

The square shape is advantageous since it leaves a relatively significant space for the windings.

Other characteristics and advantages of the invention will become apparent upon reading the following description of particular non-restrictive embodiments of the invention.

### BRIEF DESCRIPTION OF THE DRAWINGS

Reference is made to the appended drawings, wherein:

FIG. 1 is a schematic half-view in perspective of a motor according to a first embodiment of the invention;

FIG. 2 is a cross-sectional schematic view along plane II of FIG. 1 of the motor according to the first embodiment of the invention;

FIG. 3 is a cross-sectional schematic view of a stator according to an alternative embodiment; and

FIG. 4 is a view similar to FIG. 2 of a motor according to a second embodiment of the invention.

### DETAILED DISCUSSION OF THE PREFERRED EMBODIMENTS

The invention is described here relative to a single-phase electric motor having a limited motion space, for instance 70°.

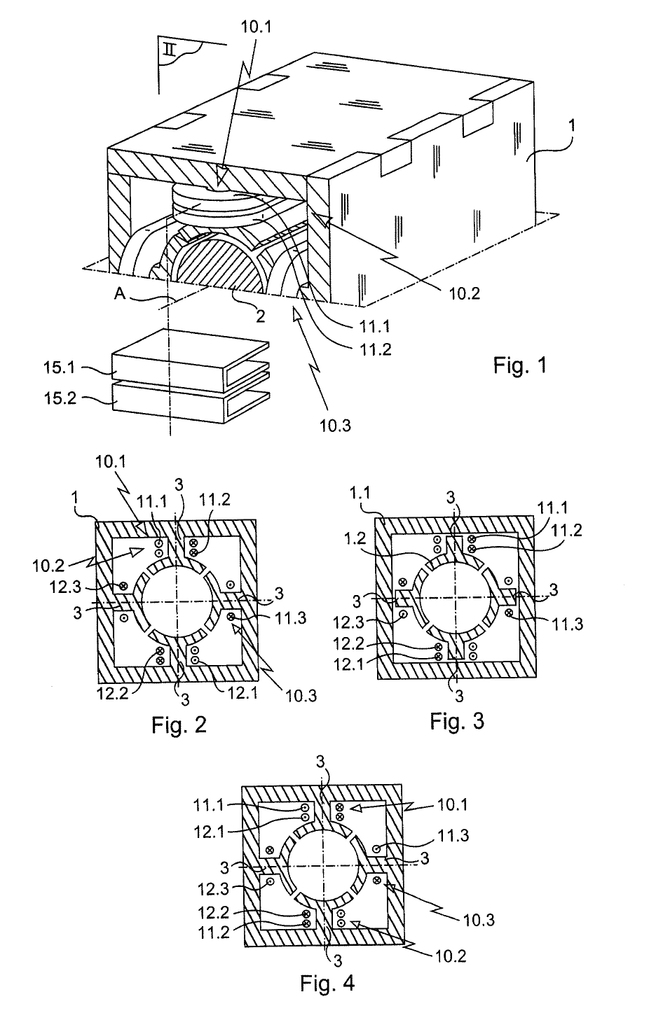

Referring to FIGS. 1 to 3, the electric motor comprises a stator 1 and a rotor 2 so mounted as to pivot in the stator 1 about an A axis. The rotor 2 is known per se and, as the invention does not relate thereto, it shall not be described in greater details hereafter.

The stator 1 has two pairs of teeth 3 symmetrically opposite each other to define two pairs of poles. The teeth 3 of one pair extend at 90° relative to the teeth 3 of the other pair. Each tooth has an enlarged free end which extends semi-circularly around a portion of the rotor 1.

The body of the stator 1 knowingly comprises sheet panels placed side by side along the A axis. The body of the stator 1 here has a section transverse to the A axis, with a square-shaped outer profile.

The body of the stator 1 is formed with angular sectors which each comprise one of the teeth 3 and which are assembled together by a finger joint. The finger pitch shall preferably be one or two panel(s). The finger joint makes it possible to increase the covering surface and to make the motor less sensitive to stray gaps.

As the motor comprises three electric circuits generally referred to as 10, each defining two windings 11, 12 in series (the electric circuits and the windings thereof are differentiated by the numbers 1, 2 and 3 which appear after the reference 10, 11, 12 respectively). The windings 11, 12 each enclose one of the teeth 3 and are substantially identical. A first one and a second one of the electric circuits 10, respectively bearing references 10.1, 10.2, are mounted on one of the two pairs of teeth 3 and a third one of the electric circuits, bearing reference 10.3 is mounted on the other one of the pairs of teeth 3.

The winding 11.1 of the first electric circuit 10.1 and the winding 11.2 of the second electric circuit 10.2 enclose one of the teeth 3 of the pair of teeth 3 and the winding 12.1 of the first electric circuit 10.1 and the winding 12.2 of the second electric circuit 10.2 enclose the other one of teeth 3 of the same pair of teeth 3. The windings 11 and 12 of each one of the first and second electric circuits 10.1, 10.2 are thus mounted on different poles of the first pair of poles.

The winding 11.3 and the winding 12.3 of the third electric circuit 10.3 each enclose one of the teeth 3 of the other pair of teeth 3.

The windings are wound about the teeth 3 prior to assembling the sectors to build the stator 1. The windings are each formed with an electrically conductive wire wrapped in an insulator and the windings of the same tooth are separated from each other by the insulator and separated from the stator by an insulator too. The insulator may consist of an annular support having a C-shaped cross-section defining a peripheral recess which accommodates the winding.

It should be noted that the windings 11, 12 have portions extending in an axial protrusion from the body of the stator 1. Said protruding portions are covered with a cap 15 (only two of which are shown in FIG. 1). The caps 15, made of a magnetic material, are so arranged as to canalise the leakage flux. This facilitates the filtering of high frequency currents generated by the decoupling control of the motor and the insulating of the windings from one another relative to such high frequency currents.

In the alternative embodiment shown in FIG. 4, the stator 1 is made of two parts, i.e. a tubular inner body 1.1 including teeth 3 which protrude outwards and a tubular engine head 1.2 enclosing the tubular inner body 1.1.

The elements identical with or similar to those described above are given the same reference numbers in the following description of the second embodiment of the invention.

The motor in FIG. 5 is identical with that of the first embodiment except for the windings 11, 12 of each one of the first and second electric circuits 10.1, 10.2, which are mounted on the same pole of the first pair of poles.

More precisely, the windings 11.1, 12.1 of the first electric circuit 10.1 enclose one of the teeth 3 of one of the two pairs of teeth and the windings 11.2, 12.2 of the second electric circuit 10.2 enclose the other one of the teeth 3 of the same pair of teeth 3.

As mentioned above, the winding 11.3 and the winding 12.3 of the third electric circuit 10.3 each enclose one of the teeth 3 of the other pair of teeth 3.

Of course, the invention is not limited to the described embodiments but encompasses any alternative solution within the scope of the invention as defined in the claims.

More particularly, the number n of electric circuits and the number N of pairs of poles may be different from three and two.

The motor may not include any cap.

The stator may include decoupling portions extending between the windings of adjacent teeth.

The stator may have different shapes and for instance a circular outer shape.

1. An electric motor comprising a stator defining a number N, at least equal to two, of pairs of poles and a rotor mounted to pivot in the stator, with the motor comprising a number n of electric circuits, each defining two windings mounted on poles of the stator, with the windings of all the circuits being substantially identical to each other, with the number n of electric circuits being greater than the number N of pairs of poles and with at least first and second electric circuits being mounted on a first one of the pairs of poles and a third one of the electric circuits being mounted on a second one of the pairs of poles.

2. The motor according to claim 1, wherein the windings of each one of the first and second electric circuits are mounted on different poles of the first pair of poles.

3. The motor according to claim 1, wherein the windings of each one of the first and second electric circuits are mounted on the same pole of the first pair of poles.

4. The motor according to claim 1, wherein each pole is formed with a tooth having an enlarged free end.

5. The motor according to claim 4, wherein the stator is formed of angular sectors which each include one of the poles and which are assembled together.

6. The motor according to claim 5, wherein the angular sectors are linked by a finger joint.

7. The motor according to claim 4, wherein the number N of pairs of poles is equal to two and the stator has a cross-section with a square-shaped outer profile.

8. The motor according to claim 4, wherein the stator is made of two parts, i.e. a tubular inner part including the poles and a tubular engine head enclosing the inner part.

9. The motor according to claim 1, wherein the windings have portions extending in an axial protrusion of the stator and the protruding portions are covered with a cap made of a magnetic material in order to canalise the leakage flux.
